(19) United States
(12) Patent Application Publication
(10) Pub. No.: US 2011/0238589 A1
(43) Pub. Date: Sep. 29, 2011

(54) COMMODITY IDENTIFICATION, VERIFICATION AND AUTHENTICATION SYSTEM AND METHODS OF USE

(76) Inventors: Don Willis, Huntington Beach, CA (US); James Freeman, Allso Vlejo, CA (US); David Rosenberg, Rancho Sants Margarita, CA (US)

(21) Appl. No.: 12/731,982

(22) Filed: Mar. 25, 2010

(51) Int. Cl. G06Q 99/00

(52) U.S. Cl. 705/318

(57) ABSTRACT

An efficient and scalable system for identifying a commodity having a specific, unique topocompositional profile has been developed that includes: enrolling at least one commodity in order to capture its topocompositional profile; matching the at least one commodity with a plurality of commodities in a commodity database; and integrating the topocompositional profile into a commodity grading system. A method of identifying a commodity having a specific, unique topocompositional profile, includes enrolling at least one commodity in order to capture its topocompositional profile; matching the at least one commodity with a plurality of commodities in a commodity database; and integrating the topocompositional profile into a commodity grading system.

### FIELD OF THE SUBJECT MATTER

The field of the subject matter is a commodity identification, verification and authentication system that is scalable and in some instances, automated. Methods of use and contemplated commodities are also disclosed.

### BACKGROUND

Collectors and sellers are constantly looking for devices and methods that can help them identify collectable commodities, along with verifying their worth and authenticating their origins. As a matter of fact, it is common in many industries that deal in collectable commodities to be vigilant against items that are either doctored to give the appearance of being worth more or altogether fakes.

There are a group of patent applications by Haddock (U.S. Ser. Nos. 12/426,861, 12/426,870, 12/426,875, 12/426,883, 12/463,839 and 12/543,325) that disclose an apparatus for identifying one coin at a time. These devices utilize a turntable to rotate a coin while illuminating the coin in order to determine surface characteristics. However, the devices are not designed to be scaled in such a way to analyze other commodities and also to analyze a large number of coins or other commodities, such that the process is automated, while at the same time providing consistent results among coins and/or commodities. Additionally, while Ser. No. 12/426,861 discusses rapidly checking a particular coin with a database of coins, it does not disclose or discuss scaling the technology, such that it can be automated and scaled up to be able to consistently evaluate at least 10,000 coins a day. To use an appropriate analogy, the Haddock patents disclose a device on the scale of a custom-made car. It would be ideal to provide an integrated system that provided a method to mass produce cars on an assembly line, including a “digital assembly line”—to use the same analogy.

To summarize, it would be ideal if a system could be developed that allows the user to identify, catalog and grade a commodity that also meets at least one of the following goals: a) can identify a number of different types of commodities, b) can identify, catalog and grade a commodity in an efficient manner, c) can identify, catalog and grade a commodity in a scalable form, wherein the system can handle at least 300 pieces per hour, d) can determine both the topical and compositional profile of a commodity, e) an integrate easily into a suitable grading system for the specific commodity, f) can identify, catalog and grade a specific member of a group of commodities in a consistent manner, and g) can result in a process that is fully automated and identifies, catalogs and grades a number of commodities as an assembly line process.

### SUMMARY

An efficient and scalable system for identifying a commodity having a specific, unique topocompositional profile has been developed that includes: enrolling at least one commodity in order to capture its topocompositional profile; matching the at least one commodity with a plurality of commodities in a commodity database; and integrating the topocompositional profile into a commodity grading system.

A method of identifying a commodity having a specific, unique topocompositional profile, includes enrolling at least one commodity in order to capture its topocompositional profile; matching the at least one commodity with a plurality of commodities in a commodity database; and integrating the topocompositional profile into a commodity grading system.

### BRIEF DESCRIPTION OF THE FIGURES

FIG. 1 shows a flow chart comprising a contemplated enrollment process.

FIG. 2 shows a flow chart comprising a contemplated matching process.

FIG. 3 shows a flow chart comprising a contemplated integrating process.

FIG. 4 shows a display screen shot of a contemplated process.

FIG. 5 shows a display screen shot of a contemplated process.

FIG. 6 shows a display screen shot of a contemplated process.

FIG. 7 shows a display screen shot of a contemplated process.

### DETAILED DESCRIPTION

Surprisingly, a system has been developed that allows the user to identify, catalog and grade a commodity that also meets at least one of the following goals: a) can identify a number of different types of commodities, b) can identify, catalog and grade a commodity in an efficient manner, c) can identify, catalog and grade a commodity in a scalable form, wherein the system can handle at least 300 pieces per hour, d) can determine both the topical and compositional profile of a commodity, e) an integrate easily into a suitable grading system for the specific commodity, f) can identify, catalog and grade a specific member of a group of commodities in a consistent manner, and g) can result in a process that is fully automated and identifies, catalogs and grades a number of commodities as an assembly line process.

Specifically, an efficient and scalable system for identifying a commodity having a specific, unique topocompositional profile has been developed that includes: enrolling at least one commodity in order to capture (and in some contemplated embodiments, digitize) its topocompositional profile; matching the at least one commodity with a plurality of commodities in a commodity database; and integrating the topocompositional profile into a commodity grading system. In addition, contemplated systems are also able to be easily and reliably calibrated, such that the calibration system facilitates the scalability and consistency of the underlying system.

As contemplated, suitable systems are both efficient and scalable, which often are not present in many conventional systems. For example, as in the Haddock patent applications, the devices are able to determine a “coinprint” within about 30 seconds, however, these devices are not able to be scaled up to examine, verify and authenticate coins in an “assembly line” type of process. This ability to be scalable, such that thousands of coins are examined, verified and authenticated in a day, is extremely important for large commodity authentication businesses. The devices disclosed in the Haddock patent applications are best for smaller dealers and dealers who may not need to authenticate many coins in a week or month. Contemplated systems can handle and/or analyze at least 300 pieces and/or commodities per hour. In other embodiments, contemplated systems can handle and/or analyze at least 400 pieces and/or commodities per hour. In yet other embodiments, contemplated systems can handle and/or analyze at least 500 pieces and/or commodities per hour. Contemplated systems are also utilized that convert topocompositional commodity images and information to digital form, but may also convert those images and information to other available electronic platforms depending on the state of the art.

Contemplated systems are those that can identify a commodity having a specific, unique topocompositional profile. As used herein, the term “commodity” may be an item that needs to be accurately and consistently valued, such as a coin, a gem, a painting or piece of art, sports card, stamps, money or vintage clothing. As used herein, the term “topocompositional” means not just the topography of the item, but also the composition of the item, if necessary, including detection of added elements meant to camouflage or hide imperfections, to deceive the grader, purchaser or potential purchaser by creating false impressions of the commodity's value or to improve the appearance of the commodity. This type of analysis is very important for commodities comprising elements, such as metals and/or carbon, or paints. If a dealer receives a coin that has been treated to look like a particular metal, it can be instructive to the authenticator to know exactly what the metal content is as compared to how it looks. Also, knowing the composition of the coin can help to verify whether that particular coin has been seen before, since specific metal compositions may be used in one year or striking as compared to another year or striking.

Turning to contemplated steps within the systems and methods disclosed herein, a contemplated system or method comprises enrolling at least one commodity in order to capture its topocompositional profile. As used herein, the term “enrolling” comprises several potential steps or combinations of steps, including barcoding, RFID tracking, identifying or otherwise uniquely marking the commodity to be authenticated or identified, so it can easily be tracked throughout the instant process and future attempts to authenticate the commodity; measuring the physical attributes, characteristics and or measurements of the commodity; scanning the surface or surfaces of the commodity, and/or taking a digital photograph of the commodity under appropriate lighting, filters and/or settings. As part of the enrolling process, the commodity can also be captured in a database or another suitable cataloging system so that it can be easily referenced during the current process or a future authentication process. Contemplated enrollment processes are designed to provide consistency to the overall authentication process, such that a commodity that is analyzed now can be easily referenced in future processes without much review. It is this consistency that allows the process to move quickly.

Specifically and in some contemplated embodiments, enrolling comprises capturing at least one physical measurement of the commodity and in some embodiments, cataloging the at least one commodity in a database. In some embodiments, enrolling comprises marking the at least one commodity so that it is uniquely identifiable. As mentioned earlier, in contemplated embodiments, marking comprises adding a barcode, a RFID tracking identifier, a laser marking or another identification to the at least one commodity.

Contemplated systems also comprise matching the at least one commodity with a plurality of commodities in a commodity database. This step is particularly important because of the fact that a different grade for a particular commodity can mean the difference between selling the commodity for five figures or six figures. Dealers and owners often resubmit commodities for reauthentication several times until the desired grade is achieved. Therefore, if an authenticator can quickly identify a commodity as having already been authenticated, it will be able to quickly review the prior grading, review the commodity as it currently stands and easily determine if anything has changed. However, it is unlikely that the grading will improve, and therefore, the authenticator will be able to easily determine if the grading should be lowered based on the commodity's current state.

Contemplated systems further comprise integrating the topocompositional profile into a commodity grading system. This step is important for new commodities in the process and also commodities that have been through the process already. Any scalable system must be able to review the topocompositional profile and follow by reliably and consistently delivering the commodity to a grading system or process and providing a consistent grade. In some embodiments, especially those involving commodities that are coins, a contemplated commodity grading system comprises the Sheldon scale.

In addition, some contemplated systems are also able to be easily and reliably calibrated, such that the calibration system facilitates the scalability and consistency of the underlying system. It is easily understood by those of ordinary skill in the art that any suitable system must be able to be easily, reliably and precisely calibrated.

Some contemplated systems comprise at least one piece of executable software that operates and/or executes at least one function of the system. This contemplated executable software can operate on a local computer, network and/or internet platform. It may be understood that executable software may be operated on any state of the art platform available at the time for running software. It is contemplated that commodity and/or topocompositional images and information may be displayed on any suitable display device, including a computer monitor, a handheld device or a combination thereof.

A method of identifying a commodity having a specific, unique topocompositional profile, includes enrolling at least one commodity in order to capture its topocompositional profile; matching the at least one commodity with a plurality of commodities in a commodity database; and integrating the topocompositional profile into a commodity grading system. In many of the contemplated embodiments of methods and systems disclosed herein, they method and/or system is at least in part automated, and in some instances, fully automated. As used herein, the phrase “at least in part automated” means that most of the system and/or method is controlled by computer, robotics, digital processes, i.e. non-human actions, but there may be some functions that require human interaction, such as loading the commodity into the system, turning on or off the system, collecting the commodity once it has been processed through the method and/or system, and/or calibrating the system, among others.

### EXAMPLE

### Coin Identification and Verification

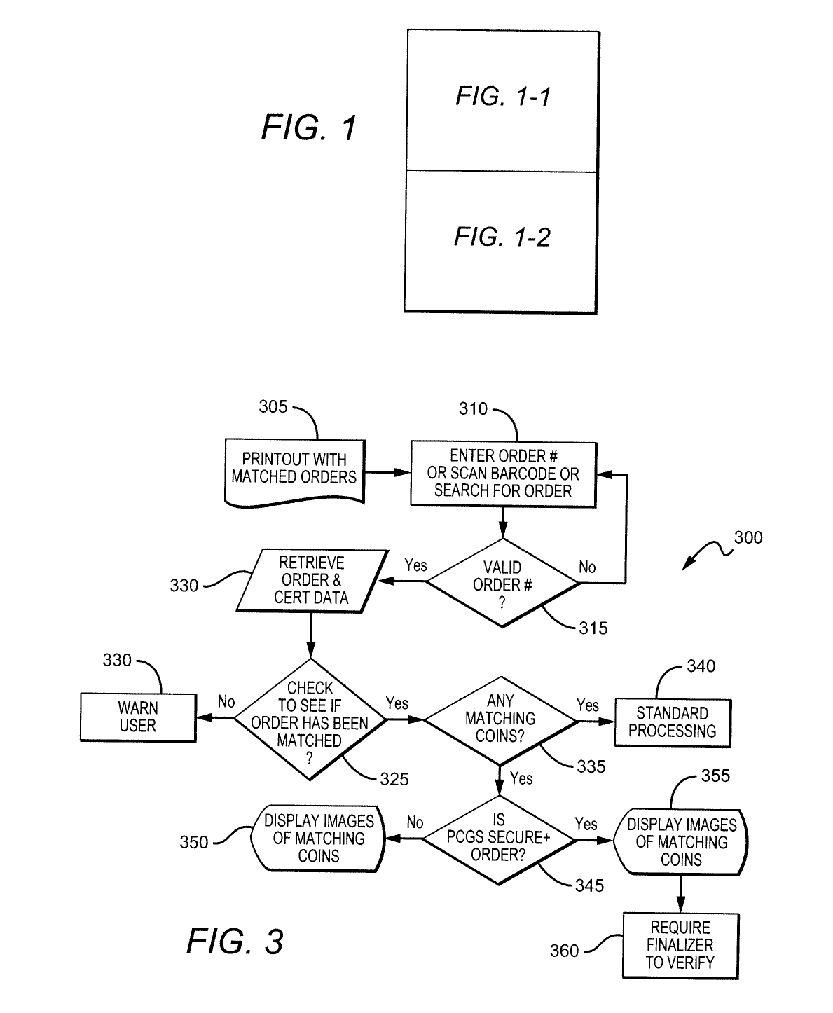

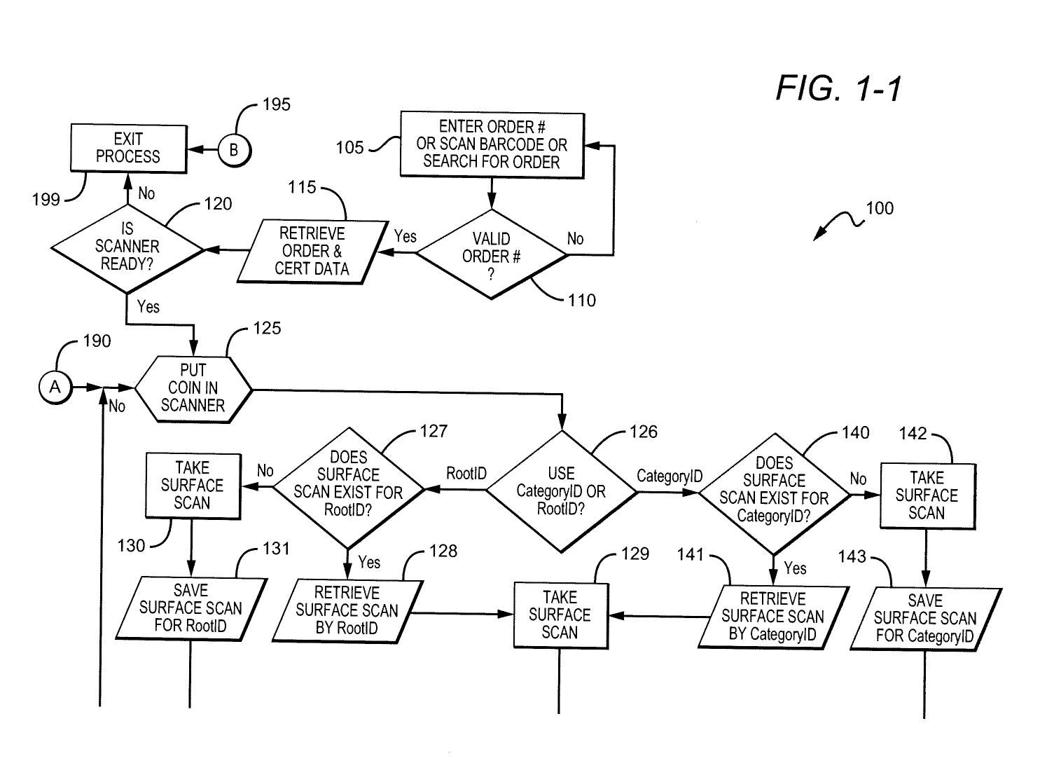

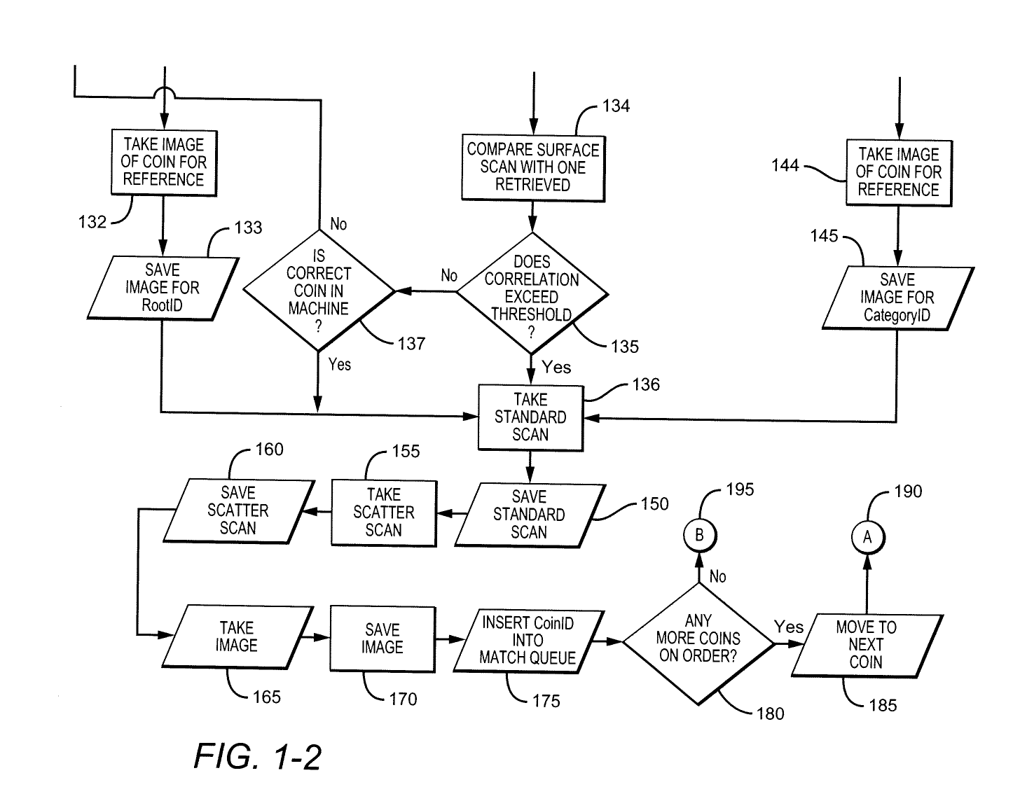

FIGS. 1 through 3 show a contemplated process where the commodity is a coin. FIG. 1 shows a contemplated enrolling process 100 that comprises several subroutines and/or steps. In a contemplated enrolling process 100, the operator (not shown) enters the order number, scans the barcode and/or searches for the order 105. If it is a valid order 110, the system retrieves the order and the certification data 115. If the order is not valid, the operator needs to reenter the original information 110. Once the order and the certification data is retrieved 115, the scanner is tested to ensure it is ready 120, and if so, the process continues to step 125. If the scanner is not ready, the system exits the process 199.

Once the coin is placed into the system 125, the category ID or the root ID can be utilized 126. In each instance, the system checks to see if the surface scan exists (127, 140) and if not, a surface scan or topocompositional image is collected (130, 142). This surface scan is saved for the ID (131, 143), the image is taken for reference purposes (132, 144) and the image is saved (133, 145). If a surface scan already exists, then it is retrieved by the system (128, 141). A surface scan of the current coin is taken 129 and compared with the one that was retrieved 134. If the correlation between the two exceeds a predetermined threshold 135, then a standard scan is taken 136. If not, then the coin in the device or machine is checked to ensure it is the correct one 137.

The standard scan is saved 150 and then a scatter scan is taken 155 and saved 160. An image of the coin is taken 165 and saved 170. The coined is inserted into the match queue 175. If there are additional coins in this order or collection 180, then the system moves to the next coin 185 and puts that coin into the scanner 190. If there are no additional coins, then the system exits the process 195.

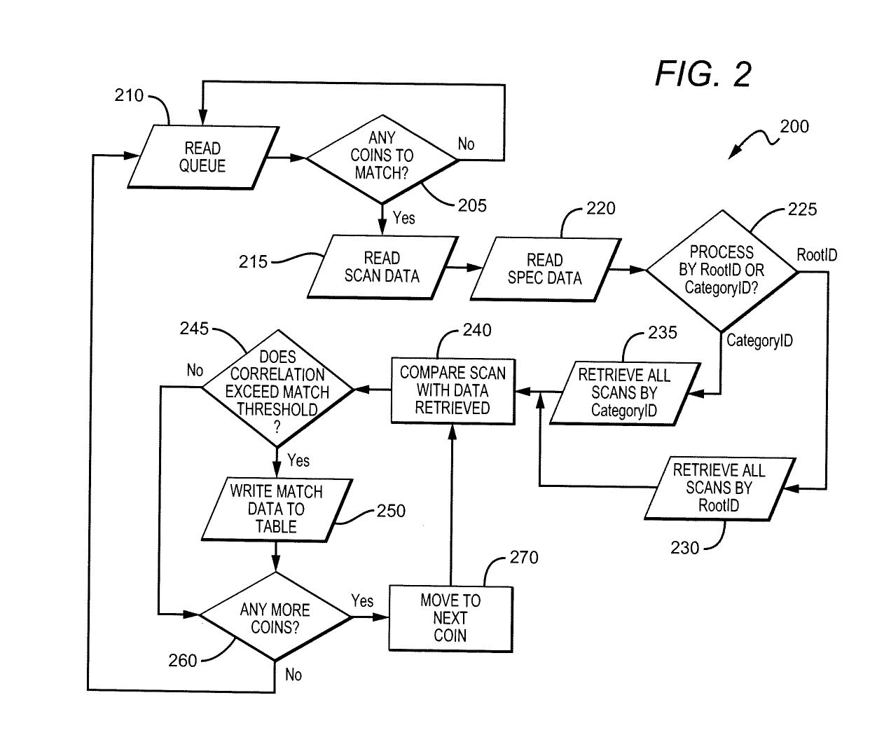

FIG. 2 shows a contemplated matching process 200 where the system reviews to determine if there are any coins to match 205, and if not, the queue is read 210 to ensure it is correct. If there are coins to match 205, then the scanning data is read 215, the specification data is read 220 and the process proceeds by either rootid or categoryid 225. In either process, all of the scans are retrieved (230, 235) and the scans compared with the data retrieved 240. If the retrieved scans correlate with the data retrieved 245, then the data is written to a table 250. If there are any more coins 260, then the system moves to the next coin 270.

In this example, FIG. 3 shows a contemplated integrating process 300 where the information from the matching process 305 is provided to this portion of the process 300. The order number or barcode is entered 310 to search for the order and the validity of the order is checked 315. If the order is valid, the data is retrieved and certified 320. The data is checked to ensure that it has been, in fact, matched 325 and if not, the user (not shown) is warned 330. If so, then the order is checked to see if there are any matching coins 335. If there are no matching coins, then the coin goes through standard processing 340. If there are matching coins, then the order is checked to see if it has been enrolled through the PCGS Secure Plus™ process 345. If not, then the images of the matching coins are displayed for checking 350. If so, then the images are displayed for checking 355 and finalized 360.

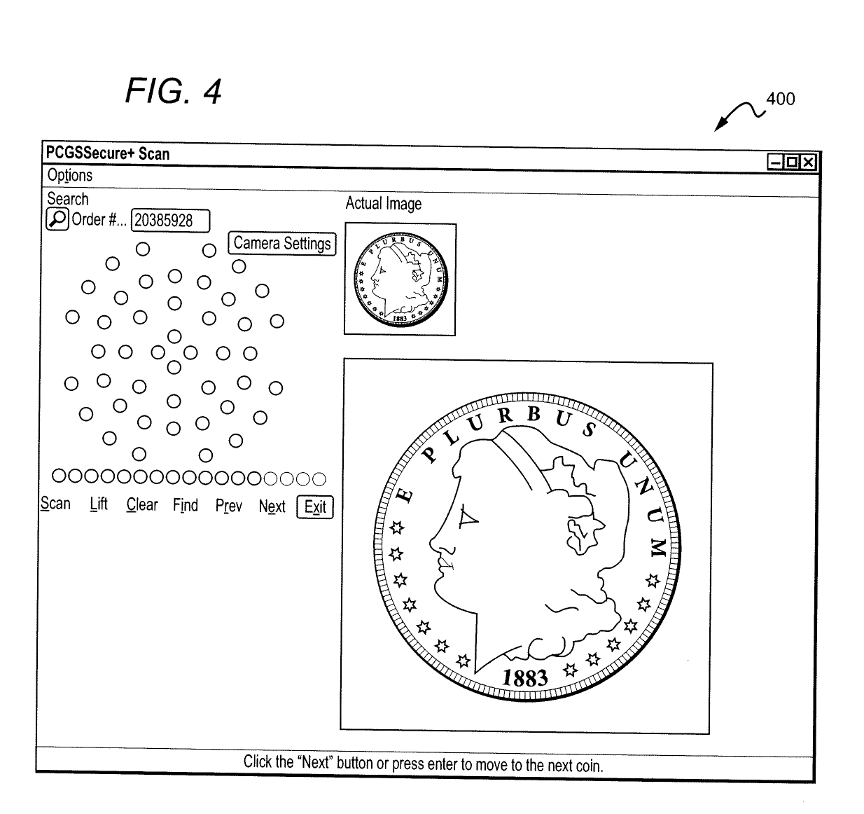

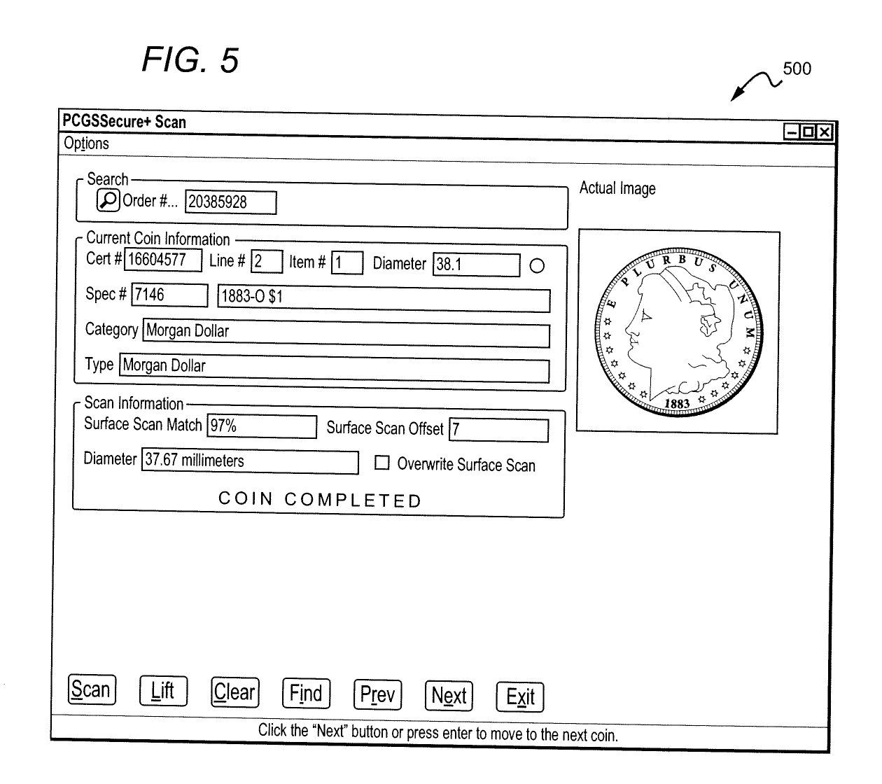

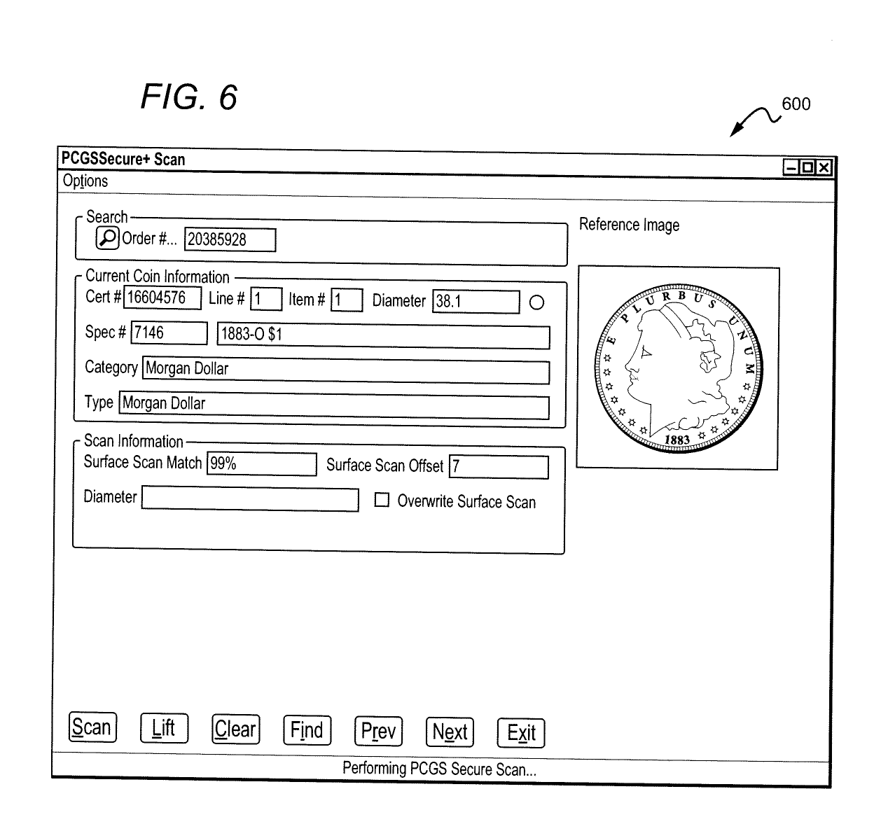

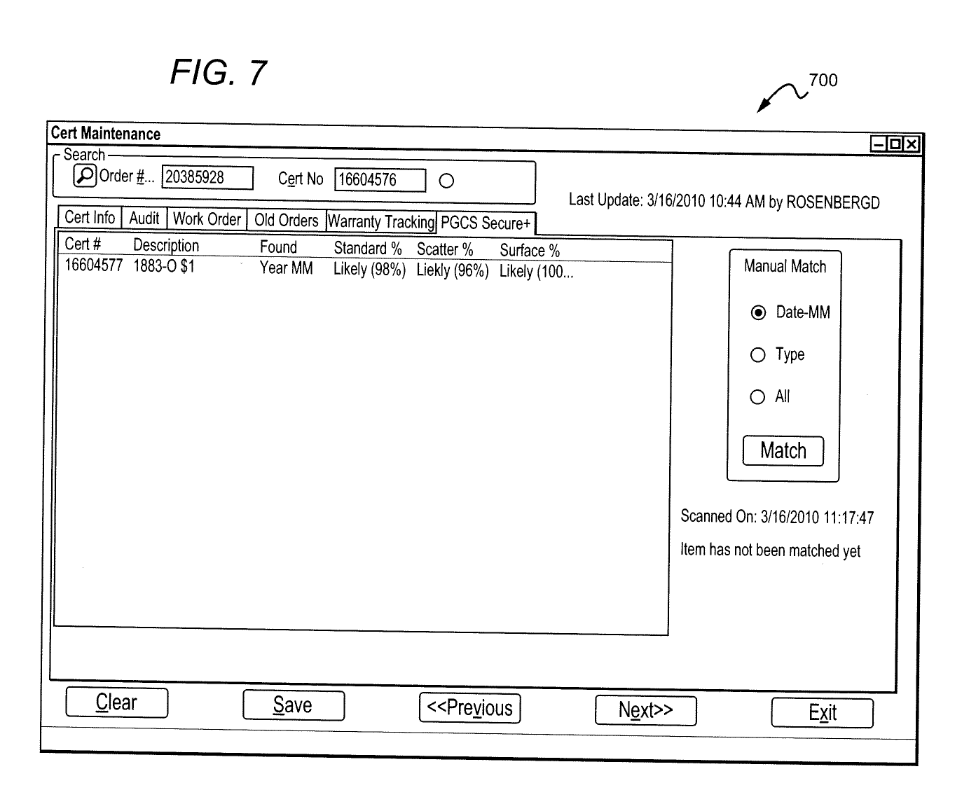

FIGS. 4-7 show display screen shots of this contemplated process showing information that is displayed to the user (not shown) along with displays of contemplated coins and coin images previously saved in the database. FIG. 4 shows a screen shot 400 from a display of a Morgan dollar image after capture into the system. FIG. 5 shows a screen shot 500 of the coin scan being completed in the enrolling and matching process. The coin is then compared with the coin in the screen shot 600 shown in FIG. 6, and finally, the coin is integrated into the matching process, which results in the screen shot 700 of FIG. 7.

Thus, specific embodiments and applications of commodity identification and verification systems, along with their methods of use, have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. An efficient and scalable system for identifying a commodity having a specific, unique topocompositional profile, comprising:
enrolling at least one commodity in order to capture its topocompositional profile;
matching the at least one commodity with a plurality of commodities in a commodity database; and
integrating the topocompositional profile into a commodity grading system.

2. The system of claim 1, further comprising automatically calibrating the system.

3. The system of claim 1, wherein the commodity comprises a coin, a gem, a painting, a piece of art, a stamp, a sports card, a piece of money or currency, a piece of vintage clothing or a combination thereof.

4. The system of claim 1, wherein the topocompositional profile comprises a topographical analysis, a compositional analysis or a combination thereof.

5. The system of claim 1, wherein enrolling comprises capturing at least one physical measurement of the commodity.

6. The system of claim 1, wherein enrolling comprises cataloging the at least one commodity in a database.

7. The system of claim 1, wherein enrolling comprises marking the at least one commodity so that it is uniquely identifiable.

8. The system of claim 7, wherein marking comprises adding a barcode, a RFID tracking identifier, a laser marking or another identification to the at least one commodity.

9. The system of claim 1, wherein matching comprises comparing the at least one commodity with a group of commodities in a commodity catalog or database.

10. The system of claim 1, wherein commodity grading system comprises the Sheldon scale.

11. A device for identifying a commodity having a specific, unique topocompositional profile utilizing the system of claim 1.

12. The system of claim 1, wherein the system comprises at least one piece of executable software.

13. The system of claim 1, further comprising displaying the topocompositional profile on a display device.

14. The system of claim 13, wherein the display device comprises a computer monitor, a handheld device or a combination thereof.

15. A method of identifying a commodity having a specific, unique topocompositional profile, comprising:
enrolling at least one commodity in order to capture its topocompositional profile;
matching the at least one commodity with a plurality of commodities in a commodity database; and
integrating the topocompositional profile into a commodity grading system.

16. The method of claim 15, further comprising automatically calibrating the system.

17. The method of claim 15, wherein the method is at least in part automated.

18. The system of claim 1, wherein the system is at least in part automated.

19. The method of claim 17, wherein the method is fully automated.

20. The system of claim 18, wherein the system is fully automated.
